(19) United States
(12) Patent Application Publication
(10) Pub. No.: US 2026/0204475 A1
(43) Pub. Date: Jul. 16, 2026

(54) METHOD FOR PRODUCING AN ELECTRICAL REGULATION WINDING, PREFABRICATED CONDUCTOR ARRANGEMENT AND ELECTRIC REGULATION WINDING

(71) Applicant: Hitachi Energy Ltd, Zürich (CH)

(72) Inventors: Gianluca Bustreo, Mirano (VE) (IT); Paolo Pavanello, Granze (PD) (IT)

(21) Appl. No.: 19/138,524

(22) PCT Filed: Dec. 8, 2023
(86) PCT No.: PCT/EP2023/084935

§ 371 Date: Jun. 12, 2025

(30) Foreign Application Priority Data
Dec. 14, 2022 (EP) 22213454.6

(51) Int. Cl. H01F 41/06; H01F 27/32; H01F 41/12

(52) U.S. Cl. CPC H01F 41/06; H01F 27/323; H01F 41/122

(57) ABSTRACT

A method for producing an electrical regulation winding is specified, wherein the method includes providing a prefabricated conductor arrangement extending in a main extension direction comprising a plurality of conductor wires being electrically insulated from one another, and winding the conductor arrangement around a winding axis to form the electrical regulation winding. Furthermore, a prefabricated conductor arrangement and an electric regulation winding are specified.

### CROSS REFERENCE TO RELATED APPLICATIONS

This application is a 35 U.S.C. § 371 national stage application of PCT International Application No. PCT/EP2023/084935 filed on Dec. 8, 2023, which in turns claims foreign priority to European Patent Application No. 22213454.6, filed on Dec. 14, 2022, the disclosures and content of which are incorporated by reference herein in their entirety.

### TECHNICAL FIELD

The present disclosure relates to a method for producing an electrical regulation winding, a prefabricated conductor arrangement and an electric regulation winding.

### BACKGROUND

Typically, for regulation windings, a plurality of single conductors are provided, each comprising an insulating material. This is, each of the single conductors has to be wrapped within the insulating material. Each of the single conductors is provided typically on a single reel. These single conductors provided on single reels are subsequently formed to an electrical regulation winding.

For the handling of the single conductors provided on single reels comparatively large handling time and space are required. Furthermore, such reels consumes a comparatively high amount of storage space.

### SUMMARY

Embodiments of the disclosure relate to a method for producing an electrical regulation winding, which can be produced particularly simple and cost efficient. Further embodiments of the disclosure relate to a prefabricated conductor arrangement and an electric regulation winding comprising such a prefabricated conductor arrangement.

According to an embodiment of the method for producing an electrical regulation winding, a prefabricated conductor arrangement is provided extending in a main extension direction comprising a plurality of conductor wires being electrically insulated from one another.

Exemplarily, the electrical regulation winding is part of an electrical power transformer. Exemplarily, the electrical regulation winding is configured to vary an output voltage of the electrical power transformers. For this purpose, the electrical regulation winding has several sections. At least some of the sections can be energised independently from one another, such that the output voltage can be changed.

Exemplarily, the electrical regulation winding is configured to change the output voltage of the power transformer by steps of at least 0.1% or at most 5% from at least 70% of a regular output voltage of the power transformer to at most 130% of the regular output voltage of the power transformer.

For example, the electrical regulation winding is a fine regulation winding. This is that the electrical regulation winding is configured to change the output voltage of the power transformer by steps of at least 0.1% or at most 1%, e.g., 0.5%, from at least 95% of a regular output voltage of the power transformer to at most 105% of the regular output voltage of the power transformer.

The term “power” here and in the following, for example, refers to power transformers adapted for processing voltages and currents of more than 100 V and/or more than 10 A, exemplary voltages up to 1000 kV and/or currents of more than 1000 A.

The prefabricated conductor arrangement is, in particular, fabricated ahead to the method described herein. The prefabricated conductor arrangement extends, for example, along the main extension direction up to a predetermined length, when it is in particular not wound up and/or rolled up.

The length of the prefabricated conductor arrangement is, for example, at least 3 m.

Furthermore, none of the conductor wires of the prefabricated conductor arrangement are in direct electrical contact with one another.

The conductor wires are each formed of the same material, for example. The material of the conductor wires comprises an electrical conducting material, such as at least one of the following materials: cooper, aluminium, aluminium alloy.

According to the embodiment of the method, the conductor arrangement is wound around a winding axis to form the electrical regulation winding. This is, after the provision of the prefabricated conductor arrangement, the prefabricated conductor arrangement is wound up around a winding axis such that the electrical regulation winding is produced.

Exemplarily, for one winding, solely one single prefabricated conductor arrangement is used.

In summary, such a method can provide, inter alia, the following advantages. Since solely a single prefabricated conductor arrangement is used, the production of the electrical regulation winding is particularly time saving.

According to a further embodiment of the method, each of the plurality of conductor wires extends parallel to the main extension direction. This is that each of the conductor wires extend parallel along the main extension direction, when the prefabricated conductor arrangement is in particular not wound up and/or rolled up.

Exemplarily, each of the conductor wires extends completely, in particular over its entire length, parallel to the main extension direction. That is that the conductor wires do not cross one another along the main extension direction. Advantageously, such a prefabricated conductor arrangement is particularly simple to produce and thus time and cost saving.

According to a further embodiment of the method, each of the plurality of conductor wires has a width in lateral direction perpendicular to the main extension direction.

For example, each conductor wire is formed of a cuboid extending along the main extension direction. Exemplarily, each conductor wire has a top surface and a bottom surface arranged opposite to one another. The top surface and the bottom surface are connected, for example, by two side surfaces arranged opposite to one another. The top surface, the bottom surface and the two side surfaces extend along the main extension direction. End regions of each conductor comprise a front surface and a back surface, both extending perpendicular to the main extension direction.

For example, the width in lateral direction corresponds to a minimal extension of the top surface and/or the bottom surface. Exemplary, the width in lateral direction is at least 1 mm and at most 50 mm, for example, 5 mm.

According to a further embodiment of the method, each of the plurality of conductor wires has a height in vertical direction perpendicular to the main extension direction.

For example, the height in vertical direction corresponds to a minimal extension of side surfaces. Exemplary, the height in vertical direction is at least 0.5 mm and at most 20 mm, for example, 1 mm.

Each conductor wire has approximately the same width, the same height and/or the same length. “Approximately” means here that due to production tolerances, the dimensions of the conductor wires can vary by at most 5% and/or at most 1%, from one another.

According to a further embodiment of the method, the lateral direction is perpendicular to the vertical direction. Exemplarily, the top surface and the bottom surface are oriented approximately perpendicular to the side surfaces.

For example, the width is larger than the height or vice versa. It is also conceivable that the width equals the height.

According to a further embodiment of the method, the winding axis is parallel to the width. Exemplarily, the winding axis is parallel to the lateral direction of the prefabricated conductor arrangement.

According to a further embodiment of the method, the prefabricated conductor arrangement comprises at least one layer. Exemplarily, at least some of the conductor wires, or all of the conductor wires for one layer, are arranged in lateral direction next to one another within one layer. For example, side surfaces of directly neighbouring conductor wires faces one another in one layer. For example, each bottom surface of the wires within one layer faces the winding axis and bottom surface of the wires within one layer faces away from the winding axis.

According to a further embodiment of the method, at least four of the conductor wires are arranged within the at least one layer next to one another in lateral direction. Exemplarily, at most twenty of the conductor wires are arranged within the at least one layer next to one another in lateral direction, e.g., ten conductor wires.

According to a further embodiment of the method, the prefabricated conductor arrangement comprises two layers. According to a further embodiment of the method, the layers are stacked on top of one another in vertical direction. Exemplarily, the layers have approximately the same width and approximately the same length such that the layers overlap with one another in lateral directions approximately congruently.

According to a further embodiment of the method, the conductor wires of the layers are overlapping in lateral direction congruently. Exemplarily, all conductor wires have approximately the same width and approximately the same length such that the conductor wires of different layers being stacked above one another in vertical direction overlap with one another in lateral directions approximately congruently.

In cross-sectional view perpendicular to the main extension direction, in particular all of the conductor wires are arranged in a matrix like manner, along rows and columns. The rows are, for example, characteristic for the layers in lateral direction. The columns are characteristic for conductor wires of different layers being stacked above one another in vertical direction.

Exemplary, in cross-sectional view perpendicular to the main extension direction, in particular all of the conductor wires are arranged on different grid points of a regular grid, e.g., a quadrangular grid. The grid can be one dimensional in case of one layer and the grid can be two dimensional in case of more than one layer.

According to a further embodiment of the method, an electrically insulating layer is arranged between neighbouring conductor wires. The electrically insulating layer is configured to separate the conductor wires spatially and electrically from one another.

For example, the electrically insulating layer is arranged along grid lines of the grid. Exemplarily, the electrically insulating layer is in direct contact with the adjacent conductor wires. This is that the electrically insulating layer is arranged in lateral direction between directly neighbouring conductor wires. Further, the electrically insulating layer is arranged in vertical direction between directly neighbouring conductor wires.

Exemplarily, the electrically insulating layer completely covers the side surfaces facing one another of directly neighbouring conductor wires arranged next to one another in lateral direction. Further, for example, the electrically insulating layer completely covers the top surface and the bottom surface facing one another of directly neighbouring conductor wires arranged above one another in vertical direction.

Exemplarily, the electrically insulating layer is in direct contact to the respective conductor wires.

The electrically insulating layer comprises at least one of the following electrically insulating materials: paper, such as kraft standard paper and/or thermal upgraded paper, enamel, such as polyvinyl alcohol, polyester, polyesterimide, polyamide-imide and/or aliphatic polyamides, aramid polymers, such as Nomex.

For example, the prefabricated conductor arrangement comprises a further electrically insulating layer arranged on a common outer surface of all conductor wires along the main extension direction. This is that such a further electrically insulating layer wraps up all conductor wires and the electrically insulating layer. Exemplarily, the common outer surface comprises all outer top surfaces, all outer bottom surfaces and all outer side surfaces of the conductor wires.

The further electrically insulating layer can be formed of the same materials than the electrically insulating layer. Further, the further electrically insulating layer can be formed of at least one of the following materials: paper, glass fiber, polyester wire, polyethylene net.

According to a further embodiment of the method, the prefabricated conductor arrangement comprises a first end region and a second end region, wherein the plurality of conductor wires are freely accessible in the first end region and the second end region. The front surface of each wire is formed in the first end region and the back surface of each wire is formed in the second end region.

For example, the front surface and the back surface are freely accessible from an outside environment. The front surface and the back surface are each configured to be electrically contacted.

According to a further embodiment of the method, at least some of the plurality of conductor wires are configured to be contacted to a tap changer. In particular, all of the plurality of conductor wires are configured to be contacted to the tap changer.

Exemplarily, the tap changer is configured to energise, i.e. switch in or out, at least one of the conductor wires.

According to a further embodiment of the method, the electric regulation winding has a plurality of turns of the prefabricated conductor arrangement around the winding axis and each turn is formed by a corresponding portion of the prefabricated conductor arrangement.

Exemplarily, an inner diameter of the electric regulation winding is at least 300 mm, e.g., 450 mm.

According to a further embodiment of the method, the turns do not overlap in radial direction. The radial direction is oriented perpendicular to the winding axis. In particular, the radial direction is represented by the vertical direction of the prefabricated conductor arrangement, when the prefabricated conductor arrangement is wound up around the winding axis.

In this embodiment, the electric regulation winding has solely one corresponding portion of the prefabricated conductor arrangement in radial direction. Neighbouring turns, i.e. the corresponding portions of the prefabricated conductor arrangement, are arranged in lateral direction next to one another along the winding axis.

According to a further embodiment of the method, the turns overlap in radial direction. In this case, the electric regulation winding has at least two corresponding portions of the prefabricated conductor arrangement in radial direction. Additionally, the turns can be further arranged in lateral direction next to one another along the winding axis.

According to a further embodiment of the method, the prefabricated conductor arrangement is provided on a single reel with a reel axis. Exemplarily, the prefabricated conductor arrangement is provided rolled up on the reel.

Advantageously, since solely a single reel is used for producing the electrical regulation winding, comparatively less time is required for preparation as well as comparatively low transportation costs are required. Further, using solely a single reel consumes only little space in a storage space and can be handled in particular simply.

According to a further embodiment of the method, the reel axis and the winding axis are parallel to one another and spaced apart from one another. This is during production of the electrical regulation winding, the prefabricated conductor arrangement, which is rolled up on the single reel, is unrolled from the single reel and wound around the winding axis.

A further embodiment relates to a prefabricated conductor arrangement for producing an electrical regulation winding, for example, with the method described herein above. Therefore, the features as described in connection with the method are also applicable for the prefabricated conductor arrangement and vice versa.

According to an embodiment, the prefabricated conductor arrangement comprises a plurality of conductor wires being electrically insulated from one another and extending in a main extension direction.

According to an embodiment of the prefabricated conductor arrangement, the plurality of conductor wires do not cross one another along the main extension direction. Such a prefabricated conductor arrangement is advantageously particularly easy and simple to produce.

Additionally, a further embodiment relates to an electric regulation winding of a power transformer, for example, with the prefabricated conductor arrangement described herein above. Therefore, the features as described in connection with the prefabricated conductor arrangement are also applicable for the electric regulation winding and vice versa.

The present disclosure comprises several aspects of a method, a prefabricated conductor arrangement and an electric regulation winding. Every feature described with respect to one of the aspects is also disclosed herein with respect to the other aspect, even if the respective feature is not explicitly mentioned in the context of the specific aspect.

### BRIEF DESCRIPTION OF THE DRAWINGS

The accompanying Figures are included to provide a further understanding. In the Figures, elements of the same structure and/or functionality may be referenced by the same reference signs. It is to be understood that the embodiments shown in the Figures are illustrative representations and are not necessarily drawn to scale.

FIG. 1 is a flow chart diagram of a method according to an exemplary embodiment,

FIG. 2 is a three dimensional schematic view of a prefabricated conductor arrangement according to an exemplary embodiment, and

FIG. 3 is a schematic view of an electric regulation winding according to an exemplary embodiment.

### DETAILED DESCRIPTION

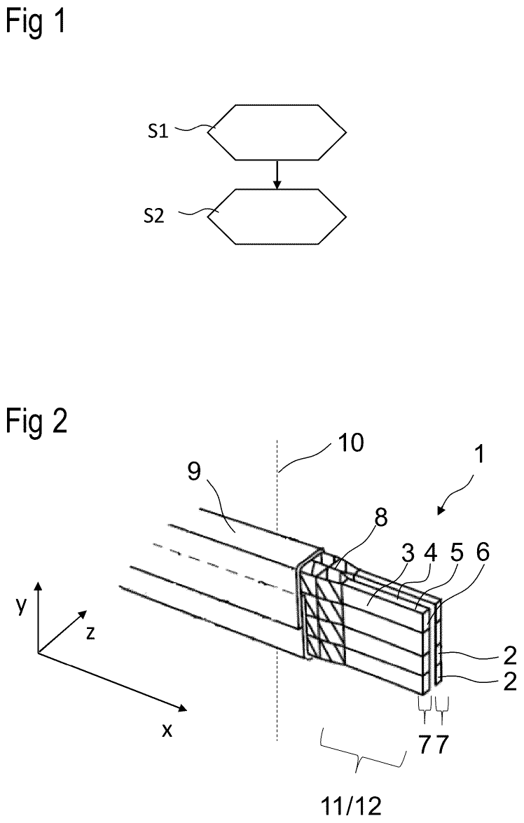

In the flow chart diagram of the method according to the exemplary embodiment of FIG. 1, in a method stage S1, a prefabricated conductor arrangement 1 extending in a main extension direction is provided. The prefabricated conductor arrangement 1 comprises a plurality of conductor wires 2 being electrically insulated from one another, which is described more detailed in connection with the exemplary embodiment of FIG. 2.

The prefabricated conductor arrangement 1 is provided on a single reel. The prefabricated conductor arrangement 1 is, in particular, rolled up on the first reel.

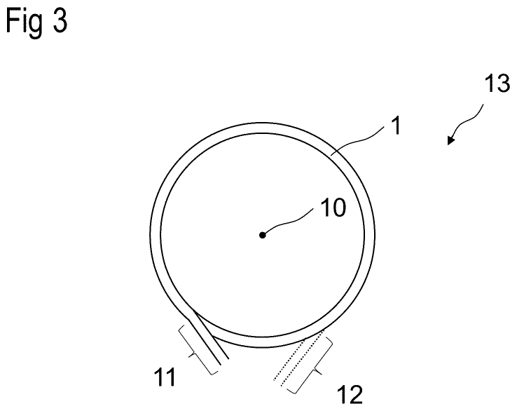

In a subsequent method step S2, the conductor arrangement is wound around a winding axis 10 to form an electrical regulation winding 13. The electrical regulation winding 13 is described more detailed in connection with the exemplary embodiment of FIG. 3. In particular, the prefabricated conductor arrangement 1 is unrolled from the reel and subsequently wound around the winding axis 10 to form an electrical regulation winding 13.

The prefabricated conductor arrangement 1 is wound around the winding axis 10 such that plurality of turns of the prefabricated conductor arrangement 1 are produced. Each turn is formed by a corresponding portion of the prefabricated conductor arrangement 1.

Each turn of the corresponding portion of the prefabricated conductor arrangement 1 comprises the plurality of conductor wires 2, each forming a corresponding sub-turn around the winding axis 10. Thus, the amount of sub-turns, corresponding to an effective number of turns of the electrical regulation winding 13, is higher than the number of turns of the prefabricated conductor arrangement 1 as a whole.

Exemplarily, in order to vary an output voltage of an electrical power transformer comprising the electrical regulation winding 13, at least some of the plurality of conductor wires 2 can be energised independently from one another. The conductor wires 2 to be energised are in particular electrically connected in a parallel manner. Thus, by changing the amount of conductor wires 2 being electrically connected parallel to one another, the number of effective turns of the electrical regulation winding 13 can be changed leading to a change of the output voltage of the transformer.

The prefabricated conductor arrangement 1 according to the exemplary embodiment of FIG. 2 comprises the plurality of conductor wires 2, each of which extends in a main extension direction of the prefabricated conductor arrangement 1, in a state where the prefabricated conductor arrangement 1 is not rolled up and/or wound around a winding axis 10.

According to this exemplary embodiment, the prefabricated conductor arrangement 1 comprises eight conductor wires 2, wherein in each case four of the wires are arranged in a respective layer 7 of the prefabricated conductor arrangement 1. This is that the two layers 7 are stacked above one another in a vertical direction, which is perpendicular to the main extension direction.

Each conductor wire 2 comprises a top surface 3 and a bottom surface 4, which are connected by two side surfaces 5. The top surface 3, the bottom surface 4 and the side surfaces 5 of each conductor wire 2 extends in the main extension direction.

Further, the conductor wires 2 of one layer 7 are arranged next to one another in a lateral direction, such that side surfaces 5 of directly neighbouring conductor wires 2 face one another. The lateral direction is perpendicular to the vertical direction and the main extension direction.

This is that the lateral direction and the main extension direction span up a main extension plane of the prefabricated conductor arrangement 1, in particular in a state where the prefabricated conductor arrangement 1 is not rolled up and/or wound around a winding axis 10.

With respect to the method described in connection with FIG. 1, the prefabricated conductor arrangement 1 is wound up such that the lateral direction is parallel to the winding axis 10. This is that bottom surfaces 4 of the conductor wires 2 faces the winding axis 10 in a state where the prefabricated conductor arrangement 1 is rolled up and/or wound around a winding axis 10.

Further, the top surfaces 3 of conductor wires 2 of one layer 7 face bottom surfaces 4 of conductor wires 2 of a directly neighbouring layer 7.

The conductor wires 2 according to FIG. 2 are arranged such that conductor wires 2 of different layers 7, which are stacked on top of one another in vertical direction, are overlapping approximately congruently, in a view from the vertical direction on the conductor wires 2. Further, the layers 7 are overlapping approximately congruently, in a view from the vertical direction on the conductor wires 2.

The prefabricated conductor arrangement 1 further comprises an electrically insulating layer 8, which is arranged between neighbouring conductor wires 2. In particular, each conductor wire 2 is electrically insulated by the electrically insulating layer 8. The top surface 3, the bottom surface 4 and the side surfaces 5 of each conductor wire 2 is covered approximately completely by the electrically insulating layer 8. “Approximately completely” means here and in the following that in end regions 11, 12 of the prefabricated conductor arrangement 1, as specified in connection with FIG. 3, the conductor wires 2 are not covered with the electrically insulating layer 8. In these end regions 11, 12, the conductor wires 2 are, e.g., freely accessible, e.g., at a front and/or a back surface 6.

Additionally, the prefabricated conductor arrangement 1 comprises a further electrically insulating layer 9, which approximately completely covers a common outer surface of all conductor wires 2, in particular a common outer surface of the electrically insulating layer 8. The further electrically insulating layer 9 wraps up all conductor wires 2 and the electrically insulating layer 8 approximately completely, such that end regions 11, 12 of the prefabricated conductor arrangement 1 of the conductor wires 2 are not covered with the further electrically insulating layer 9.

The electric regulation winding 13 according to the exemplary embodiment of FIG. 3 comprises the prefabricated conductor arrangement 1 described in connection with FIG. 2. The prefabricated conductor arrangement 1 is wound around a winding axis 10, such that each turn of the electric regulation winding 13 is corresponding to a portion of the prefabricated conductor arrangement 1.

The turns, each corresponding to a portion of the prefabricated conductor arrangement 1, are arranged next to one another in direction of the winding axis 10. The turns do not overlap in radial direction with one another. Here, the radial direction is oriented perpendicular to the winding axis 10.

The electric regulation winding 13 has a first end region 11 and a second end region 12, where the prefabricated conductor arrangement 1 is configured to be contactable externally, e.g., to a tap changer.

### REFERENCE SIGNS

1 prefabricated conductor arrangement
2 conductor wire
3 top surface
4 bottom surface
5 side surface
6 front surface/back surface
7 layer
8 electrically insulating layer
9 further electrically insulating layer
10 winding axis
11 first end region
12 second end region
13 electrical regulation winding
X main extension direction
y lateral direction
Z vertical direction

1. A method for producing an electrical regulation winding, the method comprising:
providing a prefabricated conductor arrangement extending in a main extension direction comprising a plurality of conductor wires being electrically insulated from one another, and each of the conductor wires extends completely over its entire length parallel to the main extension direction, and
winding the conductor arrangement around a winding axis to form the electrical regulation winding, wherein the prefabricated conductor arrangement is provided on a single reel with a reel axis, and the reel axis and the winding axis are parallel to one another and spaced apart from one another.

2. A method according to claim 1, wherein each of the plurality of conductor wires has a width in lateral direction perpendicular to the main extension direction, each of the plurality of conductor wires has a height in vertical direction perpendicular to the main extension direction, the lateral direction is perpendicular to the vertical direction, and the winding axis is parallel to the width.

3. A method according to claim 1, wherein the prefabricated conductor arrangement comprises at least one layer, and at least four of the conductor wires are arranged within the at least one layer next to one another in lateral direction.

4. A method according to claim 3, wherein the prefabricated conductor arrangement comprises two layers, and the layers are stacked on top of one another in vertical direction.

5. A method according to claim 4, wherein the conductor wires of the layers are overlapping in lateral direction congruently.

6. A method according to claim 1, wherein an electrically insulating layer is arranged between neighbouring conductor wires.

7. A method according to claim 1, wherein the prefabricated conductor arrangement comprises a first end region and a second end region, and the plurality of conductor wires are freely accessible in the first end region and the second end region.

8. A method according to claim 1, wherein at least some of the plurality of conductor wires are configured to be contacted to a tap changer.

9. A method according to claim 1, wherein the electric regulation winding has a plurality of turns of the prefabricated conductor arrangement around the winding axis, each turn is formed by a corresponding portion of the prefabricated conductor arrangement, the turns do not overlap in in radial direction, and/or the turns do overlap in in radial direction.

10. A prefabricated conductor arrangement for producing an electrical regulation winding according to claim 1, comprising: a plurality of conductor wires being electrically insulated from one another and extending in a main extension direction, wherein the plurality of conductor wires do not cross one another along the main extension direction.

11. An electric regulation winding of a power transformer, wherein the electric regulation winding comprises a prefabricated conductor arrangement according to claim 10.
